(19) United States
(12) Patent Application Publication
(10) Pub. No.: US 2006/0060558 A1
(43) Pub. Date: Mar. 23, 2006

(54) Method of fabricating package substrate using electroless nickel plating

(75) Inventors: Duck Young Maeng, Chungcheongbuk-do (KR); Byung Kook Sun, Seoul (KR); Jong Suk Bae, Busan (KR); Tae Hoon Kim, Daejeon (KR)

Correspondence Address: DARBY & DARBY P.C., P. O. BOX 5257, NEW YORK, NY, 10150-5257, US

(73) Assignee: Samsung Electro-Mechanics Co., Ltd., Kyunggi-do (KR)

(21) Appl. No.: 11/094,618

(22) Filed: Mar. 30, 2005

(30) Foreign Application Priority Data
Sep. 21, 2004 (KR) 2004-75512

(51) Int. Cl. C23F 1/00; H01B 13/00

(52) U.S. Cl. 216/13

(57) ABSTRACT

Disclosed is a method of fabricating a package substrate using electroless nickel plating. The method includes preparing a base substrate, on which an internal layer circuit pattern is formed through a predetermined masking process; forming an insulating layer on the base substrate to achieve interlayer electric insulation; forming a first via hole through the insulating layer to achieve interlayer electric connection; forming a seed layer on the insulating layer through which the first via hole is formed; and forming an external layer circuit pattern on the seed layer through the other predetermined masking process. The seed layer is partially or selectively flash etched so as to prevent via open and undercut formed at the external layer circuit pattern.

### INCORPORATION BY REFERENCE

The present application claims priority under 35 U.S.C. §119 to Korean Patent Application No. 2004-75512 filed on Sep. 21, 2004. The content of the application is incorporated herein by reference in its entirety.

### BACKGROUND OF THE INVENTION

1. Field of the invention

The present invention relates to a method of fabricating a package substrate using electroless nickel plating. More particularly, the present invention pertains to a method of fabricating a package substrate, in which an electroless nickel plating layer is used as a seed layer for an external layer circuit pattern constituting the package substrate, thus preventing via-hole open and undercut formed at the external layer circuit pattern, resulting in a high density microcircuit pattern.

2. Description of the Prior Art

Printed circuit board (PCB) is fabricated in such a way that a thin film, such as a copper film, adheres to one side of a phenol resin insulating plate or epoxy resin insulating plate and is etched according to a circuit pattern (a portion of the thin film rather than a circuit line is corroded and thus removed) to form a desired circuit, and the resulting structure is holed to mount parts therein.

In other words, the PCB serves to electrically connect the parts mounted therein to each other through the circuit pattern, to supply power there through, and to mechanically fix the parts therein.

In accordance with the recent rapid expansion of miniaturized and slim devices from mobile communication devices and household appliances markets to various fields, such as industrial devices, office products, communication devices, broadcasting devices, and portable computers, package technologies, such as micro ball grid array (BGA), tape carrier package (TCP), and chip size package (CSP) technologies, have been developed. Additionally, methods of fabricating package substrates, on which chips are mounted, have been watched in conjunction with advances in the package technologies.

Hereinafter, a detailed description will be given of a package substrate fabricated through a conventional build up method, with reference to FIGS. 1 and 2.

As one example of methods of fabricating the package substrate, the build up method has been used to fabricate the package substrate. In the build up method, an additional masking process is conducted to form an insulating layer 20 on a base substrate 10, on which a predetermined internal layer circuit pattern 11 is formed, thereby laminating a plurality of external layers.

In other words, when the package substrate is fabricated through the build up method, a copper clad laminate is subjected to the predetermined masking process in such a way that an insulator is applied on the base substrate 10, on which the internal layer circuit pattern 11 is formed, in a build up manner to form the insulating layer 20.

Subsequently, the insulating layer 20, which is formed on the base substrate 10, is processed by a laser to form a via hole 30 for interlayer electric connection. A plating layer 40 is formed as a seed layer to form an external layer circuit pattern on the insulating layer 20 through which a via hole is formed.

At this stage, the plating layer 40 constituting the seed layer must be formed thinly so as to form a high density microcircuit pattern. Furthermore, as shown in FIG. 1, the plating layer 40 formed in the via hole 30 is thinner than the plating layer 40 formed on a surface of the insulating layer 20, thus forming an open region 50 in the via hole 30 for connecting the internal layer circuit pattern 11 to the external layer circuit pattern.

As well, as shown in FIG. 2, the plating layer 40 constituting the seed layer is made of copper so as to have the same properties as the external layer circuit pattern 60. Accordingly, when a portion of the plating layer 40 rather than the external layer circuit pattern 60 is etched, the plating layer 40, which acts as the seed layer, and the external layer circuit pattern 60 are simultaneously etched by an etchant. Hence, the external layer circuit pattern 60 is damaged and undercut 70 is formed at a lower part of the external layer circuit pattern 60.

As described above, a copper foil, which has the same properties as the external layer circuit pattern 60, is used to form a copper foil layer 40 which is used as the seed layer in the course of forming the external layer circuit pattern 60. Accordingly, in the conventional method of fabricating the package substrate, since the thickness of the copper foil layer 40, which acts as the seed layer, is reduced to form the fine circuit pattern, problems, such as via open 50 and cracks, occur.

Furthermore, the conventional method of fabricating the package is problematic in that since the external layer circuit pattern 60 is etched in the course of etching the copper foil layer 40 as the seed layer, the undercut 70 is formed at the lower part of the external layer circuit pattern, causing delamination between layers, resulting in reduced reliability of the package substrate.

### SUMMARY OF THE INVENTION

Therefore, the present invention has been made keeping in mind the above disadvantages occurring in the prior arts, and an object of the present invention is to provide a method of fabricating a package substrate, in which a seed layer of an external layer circuit pattern is formed using electroless nickel plating, thereby preventing via open and undercut formed by flash etching, resulting in a high density microcircuit pattern.

The above object can be accomplished by providing a method of fabricating a package substrate using electroless nickel plating. The method includes the steps of preparing a base substrate, on which an internal layer circuit pattern is formed through a predetermined masking process; forming an insulating layer on the base substrate to achieve interlayer electric insulation; forming a first via hole through the insulating layer to achieve interlayer electric connection; forming a seed layer on the insulating layer through which the first via hole is formed; and forming an external layer circuit pattern on the seed layer through the other predetermined masking process. The seed layer is partially or selectively flash etched so as to prevent via open and undercut formed at the external layer circuit pattern.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an enlarged sectional view of via-hole open of a conventional package substrate;

FIG. 2 is an enlarged sectional view of undercut formed at a lower part of a circuit pattern of the conventional package substrate;

FIGS. 3a to 3n are sectional views illustrating the fabrication of a package substrate using electroless nickel plating according to the present invention;

FIG. 4 is an enlarged sectional view of a via hole formed using electroless nickel plating according to the present invention; and

FIGS. 5a and 5b are sectional views of circuit patterns formed using electroless nickel plating according to the present invention.

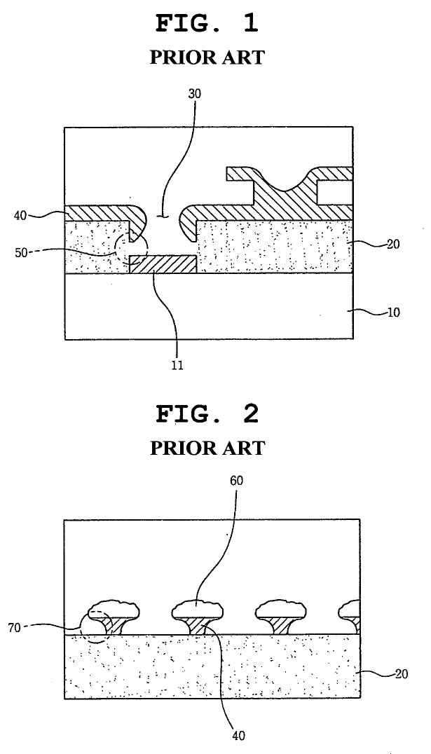

### DETAILED DESCRIPTION OF THE INVENTION

Hereinafter, a detailed description will be given of a method of fabricating a package substrate using electroless nickel plating according to the present invention, with reference to the drawings.

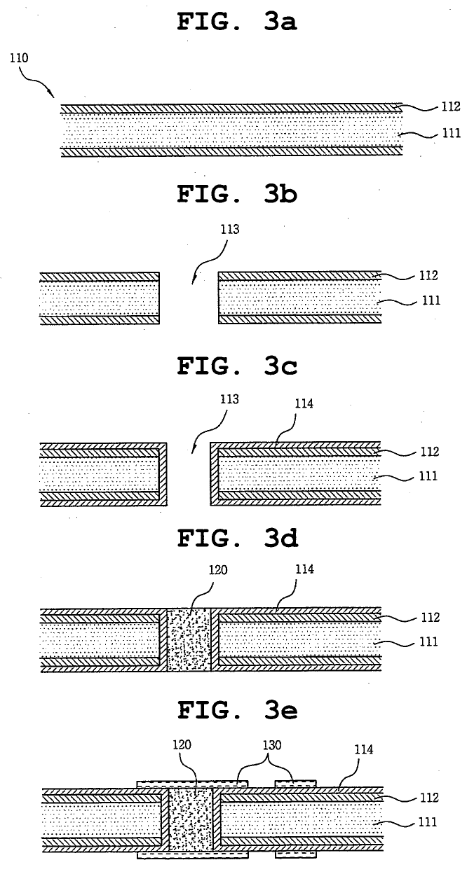

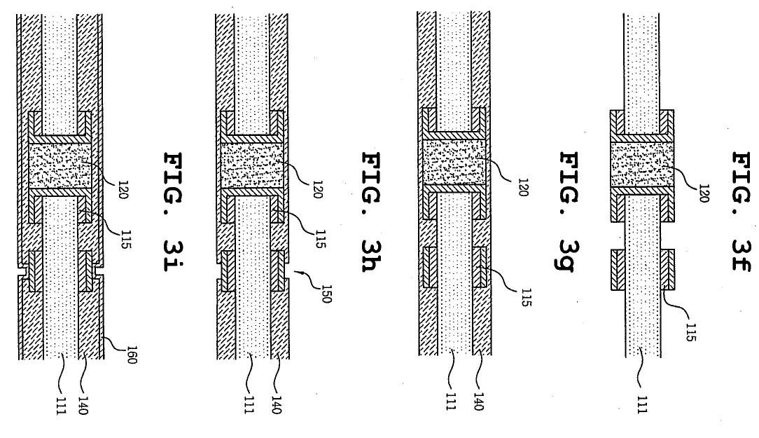

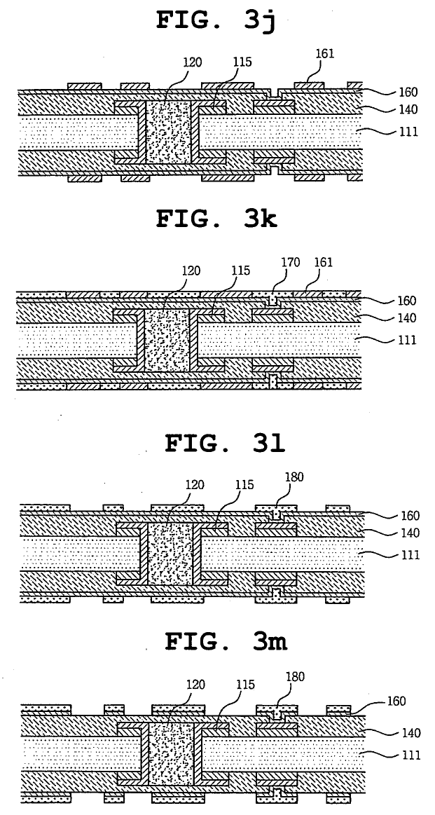

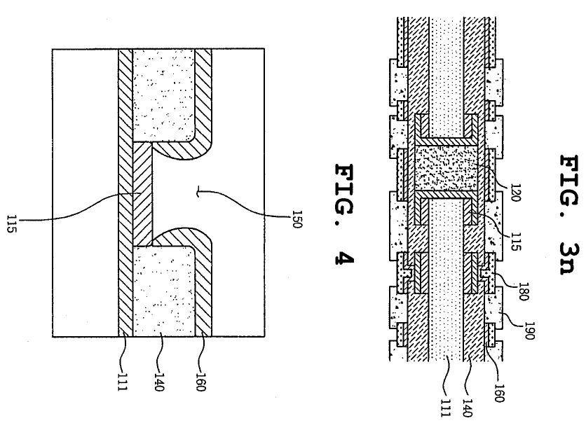

As shown in FIG. 3a, a copper clad laminate (CCL) 110, in which thin copper foils 112 are formed on both sides of an insulating layer 111, is provided.

The copper clad laminate 110 acts as a substrate used to fabricate a PCB, and has a structure in which copper 112 is thinly applied on the insulating layer 111.

In this respect, the copper clad laminate is classified into a glass/epoxy copper clad laminate, a heat-resistant resin copper clad laminate, a paper/phenol copper clad laminate, a high-frequency copper clad laminate, a flexible copper clad laminate (polyimide film), or a composite copper clad laminate depending on the application. However, the glass/epoxy copper clad laminate is most frequently employed in the course of fabricating a double-sided PCB and a multilayered PCB. Furthermore, a thickness of each of the copper foils 112 is normally 18-70 μm, but may be 5, 7, or 15 μm when a circuit pattern is made polar.

As shown in FIG. 3b, the copper clad laminate 110 is drilled to form a via hole 113.

In this regard, the via hole 113 is formed in order to achieve interlayer electric connection, and deburring and desmear processes are conducted after the drilling, thereby removing contaminants and alien substances generated in the course of processing the via hole.

After the via hole 113 is formed through the copper clad laminate to achieve electric connection between the layers as described above, as shown in FIG. 3c, the copper foils 112 and the via hole 113 are subjected to electroless copper plating and electrolytic copper plating processes to form a copper plating layer 114.

At this stage, the reason why the electrolytic copper plating process is implemented after the electroless copper plating process is first conducted is that the electrolytic copper plating process, which requires electricity, cannot be applied to the insulating layer.

In other words, the electroless copper plating process is conducted as a pretreatment process so as to form a thin conductive film required to implement the electrolytic copper plating process. Since the electroless copper plating process is disadvantageous in that it is difficult to conduct and it is economically inefficient, it is preferable that a conductive portion of a circuit pattern be formed through the electrolytic copper plating process.

After the electroless copper plating and electrolytic copper plating processes are implemented as described above, as shown in FIG. 3d, a paste 120 is packed in the via hole so as to protect electroless copper plating and electrolytic copper plating layers 114 formed on a wall of the via hole 113.

With respect to this, the paste 120 is normally made of an insulating ink, but a conductive paste may be used according to the purpose of the PCB. The conductive paste includes a mixture of any one metal, which is selected from Cu, Ag, Au, Sn, Pb, or an alloy thereof and acts as a main component, and an organic adhesive.

As shown in FIG. 3e, an etching resist pattern 130 is formed on the copper plating layer 114 to form an internal layer circuit pattern.

In this respect, a circuit pattern, which is printed on an artwork film, must be transcribed on the substrate so as to form the etching resist pattern 130. The transcription may be conducted through various methods, but the most frequently used method is to transcribe a circuit pattern, which is printed on an artwork film, on a photosensitive dry film using ultraviolet rays.

At this stage, the dry film, on which the circuit pattern is transcribed, acts as an etching resist. When an etching process is implemented using the dry film as an etching resistor, as shown in FIG. 3f, a portion of the plating layer 114, on which the etching resist pattern 130 is not formed, is removed, thereby creating the base substrate on which an internal layer circuit pattern 115 having a predetermined shape is formed.

After the base substrate, on which the internal layer circuit pattern 115 having the predetermined shape is formed, is created as described above, as shown in FIG. 3g, an insulating layer 140 for performing interlayer insulation is laminated on the base substrate to construct a build-up layer. The insulating layer 140 is normally made of a mixture of a resin and a reinforcing material.

As shown in FIG. 3h, a blind via hole 150 is formed in the insulating layer 140 to electrically connect the internal layer circuit pattern 115, which is formed on the base substrate, to an external layer circuit pattern as described later.

At this stage, the blind via hole 150 may be mechanically drilled. However, it is necessary to more precisely conduct the drilling in comparison with processing of a through hole, and thus, it is preferable to use an yttrium aluminum garnet (YAG) laser or a CO₂ laser.

After the drilling, the deburring and desmear processes are conducted so as to easily form a seed layer as described later.

The deburring process serves to remove burrs of the copper foils generated during the drilling, dust particles attached to the wall of the via hole and to surfaces of the copper foils, and finger marks. Additionally, the deburring process makes the surfaces of the copper foils rough, thus improving an attachment force of nickel to the copper foils in a subsequent plating process.

A portion of a resin constituting the substrate may be melted due to heat generated during the drilling, and adhere to the wall of the via hole. The desmear process is conducted to remove the resin adhering to the wall. The resin, which adheres to the wall of the via hole, decisively degrades the quality of the nickel plating.

After the deburring and desmear processes are conducted as described above, as shown in FIG. 3i, the insulating layer 140 is subjected to an electroless nickel plating process to form the seed layer 160 for formation of the external layer circuit pattern.

According to the present invention, a procedure of forming the seed layer comprises a cleaning & conditioning process, an activation process using a catalyst, a reduction process, the electroless nickel plating process, and an acid treatment process.

The cleaning & conditioning process is implemented to remove organics remaining on the substrate to improve wettability, and requires a condition such that when a colloid-type catalyst is used, it is possible to attach the catalyst to a glass fiber.

In the activation process using the catalyst, a catalyzing agent is adsorbed onto the insulating layer to form the catalyst necessary to activate a chemical Ni precipitation reaction on a resin. Examples of the catalyzing agent include Pd—Sn colloid (acid) or Pd ion complex (alkali: 9.5≦pH≦10.5). Adsorbed Pd ions are reduced into a metal during the subsequent reduction process.

The reduction process is implemented to produce a Pd metal, which acts in practice as the catalyst. When the Pd—Sn colloid is used, an excessive amount of Sn is dissolved and thus removed, and Sn⁺² is oxidized, thus reducing Pd⁺² to expose the Pd metal. When the Pd complex is used, Pd⁺² is reduced, thus precipitating the metal.

The electroless nickel plating process is implemented in such a way that the substrate is immersed in an electroless nickel plating liquid, which has an alkaline pH of about 7-12 and is heated to about 25-70° C., for about 1-10 min.

Finally, in the acid treatment process, the substrate, which passes through the electroless nickel plating liquid, is neutralized with acid so as to have the same pH as an electric copper plating liquid used in the subsequent process.

The seed layer 160 has a thickness of 0.2-2.0 μm, and preferably, 0.7 μm or more, thus preventing formation of an open region in the via hole 150 which is electrically connected to the internal layer circuit pattern 115, as shown in FIG. 4.

Furthermore, the seed layer 160 is formed by the electroless plating process using nickel (Ni) that is different from copper, that is, a member constituting an external layer circuit pattern 180 as described later. Thereby, it is possible to partially or selectively apply a flash etching process to the seed layer 160 after the external layer circuit pattern 180 is formed.

At this stage, a metal constituting the seed layer 160 is not limited to nickel (Ni), but metals and metal oxides, which are different from copper constituting the external layer circuit pattern 180, in detail, Sn or SnO, may be used.

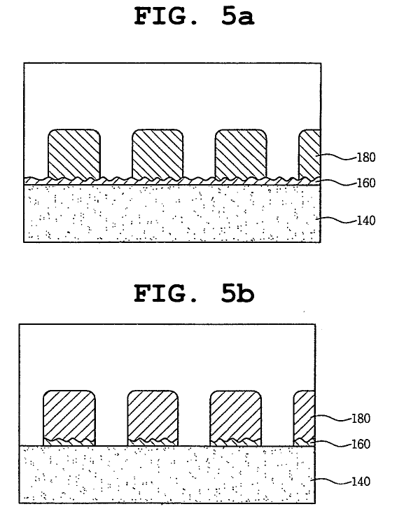

Accordingly, when the seed layer is partially or selectively subjected to the flash etching process after the external layer circuit pattern is formed on the seed layer through a predetermined masking process, as shown in FIGS. 5a and 5b, the seed layer 160 prevents undercut of the external layer circuit pattern 180, thereby forming a reliable external layer circuit pattern 180.

In this regard, FIG. 5a is a sectional view of the external layer circuit pattern 180 formed on the seed layer 160 before the etching is conducted, and FIG. 5b is a sectional view of the external layer circuit pattern 180 formed after the seed layer 160 is partially or selectively subjected to the flash etching process using a predetermined etchant.

After the seed layer is formed to prevent a via open in the insulating layer and the undercut formed at the external layer circuit pattern as described above, as shown in FIG. 3j, a resist pattern 161 is formed on the seed layer 160.

At this stage, a circuit pattern, which is printed on an artwork film, must be transcribed on the substrate so as to form the resist pattern 161. The transcription may be conducted through various methods, but the most frequently used method is to transcribe a circuit pattern, which is printed on an artwork film, on a photosensitive dry film using ultraviolet rays. Recently, a liquid photo resist (LPR) is sometimes used instead of the dry film.

After the resist pattern 161 is formed as described above, as shown in FIG. 3k, an electrolytic copper plating process 170 is conducted to form the external layer circuit pattern.

At this stage, a plating liquid, which is used to conduct the electrolytic copper plating process, includes Cu²⁺; H₂SO₄ for improving conductivity of the plating liquid; Cl⁻, which acts as a promoter during the plating process and helps to form a black film for a fusible anode; a brightener for promoting plating growth; and a flattening agent for suppressing the plating growth.

Subsequently, as shown in FIG. 31, the resist pattern 161, which is applied on a portion of the seed layer rather than the other portion on which the external layer circuit pattern is to be formed, is stripped to form the external layer circuit pattern 180 having a predetermined shape and to interrupt the seed layer 160.

After the seed layer 160 is interrupted as described above, as shown in FIG. 3m, the interrupted seed layer 160 is removed using a predetermined etchant, in detail, an etchant which does not etch the external layer circuit pattern 180 but etches the interrupted seed layer 160, thereby completing the formation of the external layer circuit pattern 180 having the predetermined shape.

Next, as shown in FIG. 3n, a PSR ink (photo imageable solder resist mask ink) 190 is applied so as to protect the external layer circuit pattern 180 and to prevent a solder bridge between external layer circuit patterns 180 during a soldering process, thereby creating the package substrate using the electroless nickel plating.

As described above, a method of fabricating a package substrate using electroless nickel plating according to the present invention is advantageous in that a thin seed layer is formed using the electroless nickel plating instead of a thick seed layer formed using conventional electroless copper plating, resulting in the miniaturized package substrate and a high density microcircuit.

Other advantages are that the seed layer and a circuit layer are made of different materials, thus preventing via open, undercut, and delamination occurring in the course of etching the seed layer, resulting in significantly improved reliability.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

What is claimed is:

1. A method of fabricating a package substrate using electroless nickel plating, comprising the steps of:
preparing a base substrate, on which an internal layer circuit pattern is formed through a predetermined masking process;
forming an insulating layer on the base substrate to achieve interlayer electric insulation;
forming a first via hole through the insulating layer to achieve interlayer electric connection;
forming a seed layer on the insulating layer through which the first via hole is formed; and
forming an external layer circuit pattern on the seed layer through the other predetermined masking process.

2. The method as set forth in claim 1, wherein the step of preparing the base substrate comprises the steps of:
drilling a copper clad laminate to form a second via hole for interlayer electric connection;
electroless and electrolytic copper plating the copper clad laminate to form a plating layer;
applying a dry film (D/F) on the plating layer;
aligning an artwork film, on which a predetermined circuit pattern is formed, on the dry film;
irradiating the ultraviolet rays through the artwork film to harden the dry film;
removing an unhardened portion of the dry film to etch the interrupted plating layer; and
removing a portion of the dry film applied on an unetched portion of the plating layer, to form the predetermined internal layer circuit pattern.

3. The method as set forth in claim 1, wherein forming the seed layer comprises the step of electroless plating using nickel.

4. The method as set forth in claim 1, wherein forming the seed layer comprises the step of electroless plating using at least one of tin (Sn) and tin oxide (SnO).

5. The method as set forth in claim 1, wherein forming the seed layer a thickness of 0.2-2.0 μm comprises the step of electroless plating the seed layer.

6. The method as set forth in claim 1, wherein the step of forming the external layer circuit pattern comprises the steps of:
applying a dry film (D/F) on the seed layer;
aligning an artwork film, on which a predetermined circuit pattern is formed, on the dry film;
irradiating the ultraviolet rays through the artwork film to harden the dry film;
removing an unhardened portion of the dry film to interrupt the seed layer;
electroless and electrolytic copper plating the interrupted seed layer to form a plating layer;
removing a portion of the dry film formed separate from the plating layer to form the predetermined external layer circuit pattern; and
etching a portion of the seed layer separate from a position where the external layer circuit pattern is formed.

7. The method as set forth in claim 6, wherein forming the seed layer comprises the step of at least one of partially and selectively flash etching.
